(19) United States
(12) Patent Application Publication
(10) Pub. No.: US 2019/0172012 A1
(43) Pub. Date: Jun. 6, 2019

(54) HEALTHCARE SUPPLY CHAIN MANAGEMENT SYSTEMS, METHODS, AND COMPUTER PROGRAM PRODUCTS

(71) Applicant: Standvast Healthcare Fulfillment, LLC, Washington, DC (US)

(72) Inventors: Cayce Roy, Washington, DC (US); Tim Hwu, Washington, DC (US); John Appert, Washington, DC (US)

(73) Assignee: Standvast Healthcare Fulfillment, LLC, Washington, DC (US)

(21) Appl. No.: 16/210,544

(22) Filed: Dec. 5, 2018

Related U.S. Application Data
(60) Provisional application No. 62/594,914, filed on Dec. 5, 2017.

(51) Int. Cl. G06Q 10/08; G06Q 10/06

(52) U.S. Cl. CPC G06Q 10/0875; G06Q 10/06315; G06Q 40/08; G06Q 10/0833; G06Q 10/0837; G06Q 10/0832

(57) ABSTRACT

In one aspect, a method for a healthcare supply chain management system is provided. The method may include extracting schedule and procedure information from electronic health record systems. The method may include ordering required medical items at least based on the extracted schedule and procedure information. The method may include creating an order for a medical procedure at least based on the extracted schedule and procedure information, where the order includes a request for at least one or more medical items related to the medical procedure. The method may include managing the order for the medical procedure. The method may include employing machine learning to optimize the healthcare supply management system.

### CROSS REFERENCE TO RELATED APPLICATION

The present application claims the benefit of priority to U.S. Provisional Application Ser. No. 62/594,914, filed on Dec. 5, 2017, which is incorporated herein by reference in its entirety.

### BACKGROUND

### Field of Invention

The present invention relates generally to systems, methods, and computer program products for a lean supply chain system applied to healthcare. More specifically, in exemplary embodiments, the present invention relates to systems and methods, and computer program products for mass customized order fulfillment, closed loop inventory management and feedback systems, real-time monitoring and data flows, and machine learning based feedback for both clinicians and hospital administrators.

### Discussion of Background

The healthcare industry has experienced significant change and innovation in therapeutic and procedural care for patients over the last decade. However, the supply chain supporting this new environment is virtually unchanged over the last decades and is engineered to support a fee-for-service, hospital-based provider model which ignores proven technology and best practice developments within the supply chains of other dynamic industries. The current healthcare supply chain is well behind most industry models with respect to costs, quality and services provided, thereby creating a need to re-engineer and adopt new practices and models. As an example, the current healthcare supply chain creates approximately $100B in direct waste, excess costs and inventory within the surgical environment in the United States. Further, there are indirect costs resulting from government-reported defect rates (medical errors being the third largest cause of death) and a large self-reported clinical burn-out rate.

Currently, there are approximately 5,500 hospitals in the United States accounting for $1 trillion of operating expenses and consumable spending within the hospital provider network in the United States, with a $300B addressable opportunity to reduce Surgery/Procedural Supply Chain-related costs.

### SUMMARY

Disclosed herein are, for example, systems, methods, and computer program products for a lean supply chain system applied to healthcare with mass customized order fulfillment, closed loop inventory management and feedback systems, real-time monitoring and data flows to connect the healthcare supply chain from patient to manufacturer, and machine learning based feedback for both clinicians and hospital administrators.

The current disclosure focuses on the surgical supply preference items and medical-surgical products, as these are the highest percent of a hospital supply costs with the majority of effort and resources within a hospital. However, this is not required, and the embodiments disclosed herein may be applied to other areas of the hospital, such as pharmaceutical supplies, sterile instruments, and the non-surgery related areas of the hospital. In addition, there are tens of thousands of ambulatory centers, doctor's offices and community living facilities across North America that may utilize the embodiments described in the current disclosure.

The current disclosure is directed to a mass-customized, e-commerce healthcare fulfillment supply chain solution that is technology-enabled and designed by starting with clinician/patient as the focus. Some aspects of the current disclosure replace the status quo of the last several decades. For example, some embodiments disclosed herein simplifies the healthcare supply chain by removing the complexity and burdens on the clinician and the hospital administration to enable a renewed focus on the mission at hand—cost effective, high quality patient care. Some embodiments disclosed herein transform the flow of supplies by removing tasks and inventory from the hospital and providing proprietary technology which connects with existing hospital systems to leverage prior IT investments, mitigate costs and limit change management resources. Some aspects of the current disclosure may be utilized to deliver tens of millions of savings for a typical provider with a return on investment in less than a year.

In an aspect, there is provided a method for a healthcare supply chain management system. The method includes extracting schedule and procedure information from electronic health record systems. The method includes ordering required medical items at least based on the extracted schedule and procedure information. The method includes creating an order for a particular medical procedure at least based on the extracted schedule and procedure information, wherein the order comprises a request for at least one or more medical items related to the particular medical procedure. The method includes managing the order for the particular medical procedure. The method includes employing machine learning to optimize the healthcare supply management system.

In some embodiments, the schedule and procedure information comprises at least one or more of electronic medical records (EMR), electronic health records (EHR), customer billing information, finance accounting information, and enterprise resource planning (ERP) information.

In some embodiments, managing the order for the particular medical procedure comprises scheduling replenishment of the one or more medical items related to the particular medical procedure at a warehouse and scheduling delivery of the one or more medical items to a facility conducting the particular medical procedure.

In some embodiments, managing the order for the medical procedure further comprises fulfilling the one or more medical items using mass customized e-commerce fulfillment capabilities.

In some embodiments, managing the order for the medical procedure further comprises tracking the one or more medical items delivered to the facility, wherein tracking the one or more medical items comprises tracking the one or more medical items delivered to a point of use at the facility and tracking any non-used items of the one or more medical items delivered to the point of use. In some embodiments, at least one of barcodes, RFID, voice recognition, cameras, visual recognition systems, and a block chain system is used to track the one or more medical items delivered to the facility.

In some embodiments, managing the order for the medical procedure further comprises determining whether all of the delivered one or more medical items were used in the medical procedure and as a result of determining that all of the one or more medical items were not used in the medical procedure, determining one or more medical items that were not used in the medical procedure.

In some embodiments, employing machine learning to optimize the healthcare supply management system comprises optimizing a future order creation for the medical procedure based on the one or more medical items that were not used. In some embodiments, optimizing the future order creation for the medical procedure is further based on at least one or more of: (i) quality of the medical procedure outcome and (ii) cost of the medical items.

In some embodiments, employing machine learning to optimize the healthcare supply management system comprises automatically managing an inventory at the facility based on the one or more medical items that were not used. In some embodiments, employing machine learning to optimize the healthcare supply management system comprises automatically managing the inventory at the facility further based on at least one or more of the extracted schedule and procedure information, changing lead times, and healthcare supply chain processes. In some embodiments, employing machine learning to optimize the healthcare supply management system comprises providing a recommendation for the at least one or more medical items related to the medical procedure.

In some embodiments, machine learning comprises at least one or more of unsupervised classification algorithms and predictive algorithms.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIG. 1 shows a conventional process flow of healthcare supply.

FIG. 2 shows a healthcare supply chain management system according to one embodiment.

FIG. 3 shows aspects of a healthcare supply chain management system according to some embodiments.

FIG. 4 shows aspects of a healthcare supply chain management system according to some embodiments.

FIG. 5A illustrates a flowchart of a method according to one embodiment.

FIG. 5B illustrates a flowchart of a method according to one embodiment.

FIG. 5C illustrates a flowchart of a method according to one embodiment.

FIG. 6 illustrates an exemplary architecture of a communication system according to one embodiment.

FIG. 7 illustrates a block diagram of a device according to one embodiment.

FIG. 8 illustrates a block diagram of a server according to one embodiment.

FIG. 9 illustrates a flowchart of a method according to one embodiment.

FIG. 10 illustrates a flowchart of a method according to one embodiment.

FIG. 11 illustrates a flowchart of a method according to one embodiment.

### DETAILED DESCRIPTION

### The Conventional Process of Healthcare Supply

Even with the advance of purchasing aggregation and hospital consolidation efforts, most providers maintain an independent and separate inventory within each hospital encompassing numerous inventory storage locations with disconnected processes and supply chain systems. Such inventory storage systems create numerous wasted steps, manual intervention, redundant supplies and unnecessary hospital efforts.

In current hospital supply chains, supply chain analysts review historical order patterns to forecast supply demand. The supply chain analysts or clinical teams determine required quantities and place orders for medical supplies with multiple vendors or distributors. Bulk shipments are received and stored at the hospital or an offsite location in various locations across the hospital network (also referred to as par locations). The supply levels are manually inspected across the multiple locations regularly at each storage location within the hospital or the offsite location and when stock levels drop below manually prescribed levels, orders are placed with central supply or directly with the distributor/vendor to replenish the medical supplies at each location. In some instances, the supplies are directly ordered and managed by the clinical teams and stored in supply closets that are not systematically managed or counted

To prepare for a patient case, clinicians rely on well-stocked supply closets, also referred to as par locations, to pick items for each patient care episode. A pick list containing the pick items for each patient care episode is based on either a physical or electronic preference card created for each physician, procedure, and location of the procedure. In current hospital supply chains, the preference cards are often not kept up to date with information maintained based on a surgical specialist with experience with a specific surgeon and/or procedure.

For specialty medical items, the clinicians often maintain the inventory directly. For example, the clinicians count, order, receive, and store the supplies themselves. This process is usually performed by the clinicians without systems to provide requirements for any upcoming procedures. Orders for specialty medical items are often hand-keyed into the system by the clinicians or verbally communicated by the clinicians to a sales representative.

In current hospital supply chains, once a medical procedure is completed, unused medical supplies are thrown away, left behind in each operating room, or returned to be restocked on the supply shelves. There is often no reconciliation of what was unused in a given procedure. The clinicians sometimes manually edit billing documentation to reflect the actual quantity of medical items used for each case. The medical items that cannot be found within the system are logged as a “generic” which many or may not be reconciled during an audit step.

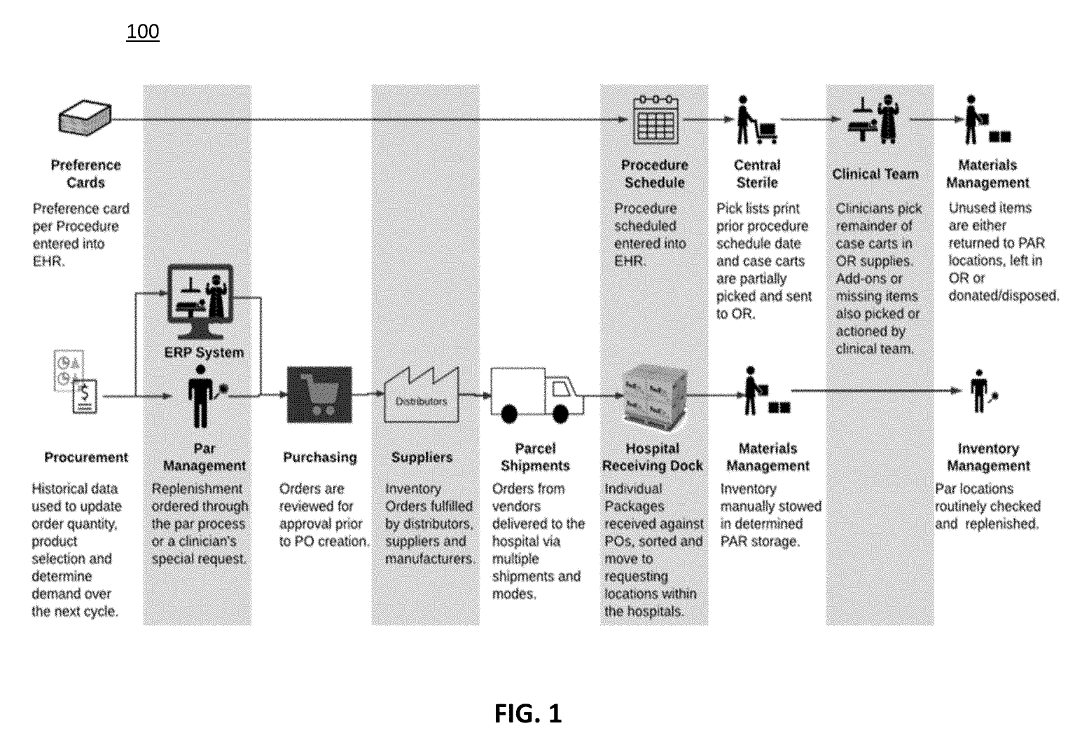

An illustration of the conventional process flow of healthcare supply 100 is shown in FIG. 1. As shown in FIG. 1, the disconnected supply and clinical processes of the convention process flow 100 represent a significant gap, which can lead to overstocking on unnecessary inventory and shortages. Each step of the conventional process flow of healthcare supply 100, e.g., ordering, receiving, picking, auditing, is performed with poorly designed solutions or without systems to aid in identification of errors or check errors that may lead to errors in documentation, billing, or even treatment of a patient.

Furthermore, the current healthcare supply chain cannot service efficient in-home care offerings, local treatment centers or assisted care support due to its inability to reliably sort and ship low unit of measure orders, reliably ship orders of any size, and lack the systems to effectively manage and track shipments across thousands of customers. As such, given the shift of healthcare services closer to the patient, e.g. in the patient's home, there is a need for new capabilities to enhance convenience, trust, accessibility, and influence over patient care.

### The Improved Healthcare Supply Chain Management System

In the context of the current disclosure, the term mass-customized e-commerce fulfillment means a capability to efficiently fulfill and reliably deliver a diverse set of products in a particular order to meet numerous individual customer needs with the benefits of mass customization of individual orders. In the context of the current disclosure, a service area means a geographic area where a forward deployed fulfillment center (FDFC) can service hospitals within a predetermined area. In some non-limiting embodiments, the service area may be a geographic area to service hospitals within a 3-hour drive of the FDFC creating an area of roughly a 200-mile radius. In the context of the current disclosure, FDFC means a primary order fulfillment capability for a service area. In the context of the current disclosure, “Last Mile” means local delivery to hospitals, care centers or homes. In the context of the current disclosure, a consolidated service center (CSC) means a center that is currently deployed within provider networks to reduce reliance on distributors and seek to generate further material cost savings. In the context of the current disclosure, kits/kitting means standard consolidated packs established to serve a variety of surgeons for a particular procedure usually prepared months in advance to the lowest common denominator of various surgical needs creating waste. In the context of the current disclosure, usage data means information regarding the use and/or non-use of medical items in a specific medical procedure.

Some aspects of the current disclosure simplify processes for hospital teams, mitigate the impact on IT resources or systems and synergize with other change management initiatives. Some aspects of the current disclosure provide a complete transformation, starting with the clinician/patient needs to: (1) reduce clinician workload by removing the need to manually manage or order supplies while not requiring an incremental effort or a complex system for clinicians or hospital teams to manage inventory better, (2) eliminate disjointed individual efforts to replenish and track inventory stored in the hospital while providing a non-complex hospital managed enterprise inventory tracking and replenishment system, (3) actively manage the backend logistics with new systems supporting existing contracts and agreements while avoiding the addition of incremental complexity to contracts, agreements, or purchasing efforts, and (4) enable machine learning algorithms to continuously recommend or fix problems at the root cause sometimes before the problems happen.

Some aspects of the current disclosure are directed to a mass-customized, e-commerce fulfillment supply chain system that are technology-enabled and clinician/patient focused, with a closed loop data environment and machine learning systems. The combined approach as disclosed herein is unique as it reengineers and transforms the current healthcare supply chain.

Some aspects of the current disclosure access available scheduling, preference card, patient outcomes, catalog or ERP data on items purchasing, and procedure data from existing hospital systems using a proprietary middleware to integrate to existing hospital systems. In some embodiments, the proprietary middleware is used to extract schedule and procedure information from electronic health record (EHR) systems. In some embodiments, the schedule and procedure information comprises at least one or more of electronic medical records (EMR), EHRs, customer billing information, finance accounting information, and enterprise resource planning (ERP) information. The extracted schedule and procedure information enables the creation of a patient/clinician/procedure specific order in some embodiments. Some aspects of the current disclosure connects with the ERP systems or current catalog to replenish medical supplies into a FDFC and efficiently fulfill the materials for a specific patient procedure order using a mass-customized, e-commerce fulfillment capability—delivering exactly the right product at the right time for specific patient procedures. The orders containing the required medical supplies are scanned into containers, sealed, and tracked to the hospital and the area where the procedure is performed. Items that are not used or added are accounted for by the clinicians or supply chain team at the hospital using tools/processes provided by some aspects of the current disclosure. The aspects of the current disclosure described above create a closed loop of information and data to ensure a complete reconciliation of each item for each procedure/clinician/patient, thereby allowing each item used to meet meaningful use requirements. The closed loop of information drives reporting and machine learning tools provided by some aspects of the current disclosure to optimize the items for each procedure based on the quality of outcomes, costs of supplies, and patient needs.

In some embodiments, the healthcare supply chain management system will address healthcare interoperability through a middleware. In some embodiments, the middleware implement protocols with a software layer between the healthcare enterprise applications. The middleware platform facilitates a secure, HIPAA compliant access of EMR data directly from the various databases where the EMR is stored. In some embodiments, the middleware adopts a cloud based, language-independent platform and specifies interfaces and exchange protocols to communicate between healthcare enterprise applications. In some embodiments, the middleware extracts patient schedule, physician preference, and procedural outcome data from EMRs and item catalog and cost/revenue data from the ERP and feeds the data into the proprietary healthcare supply chain management system.

Some aspects of the current disclosure remove excess inventory/safety stock from the hospital. To be successful and not negatively impact patient care, three key elements are provided by the embodiments disclosed herein in order to deliver the highest and most accurate levels of service, which does not occur within the conventional healthcare supply chain. Some aspects of the current disclosure provide a new healthcare supply chain system comprising the three key elements as one product and each key element is directed to delivering the benefit.

Some aspects of the current disclosure compares a patient outcome with procedural information on the items used/not used from within the proprietary system to provide cost/outcome comparisons in order to support improved clinician decision making. The comparison of the patient outcome with the procedure information on the items used/not used may also be provided as data for machine learning systems to recommend or implement improvements for the costs and/or care for a patient.

Some aspects of the current disclosure feeds usage data into patient billing or revenue cycle software to provide accurate accounting of products used and pricing transparency for the patient encounter. This cost, revenue, and outcome data by procedure, clinician, or hospital may be used to support analysis of performance by clinician, hospital, providers, or a combination across waste, quality of care, value, profitability, and other factors to support improvement of performance within health care.

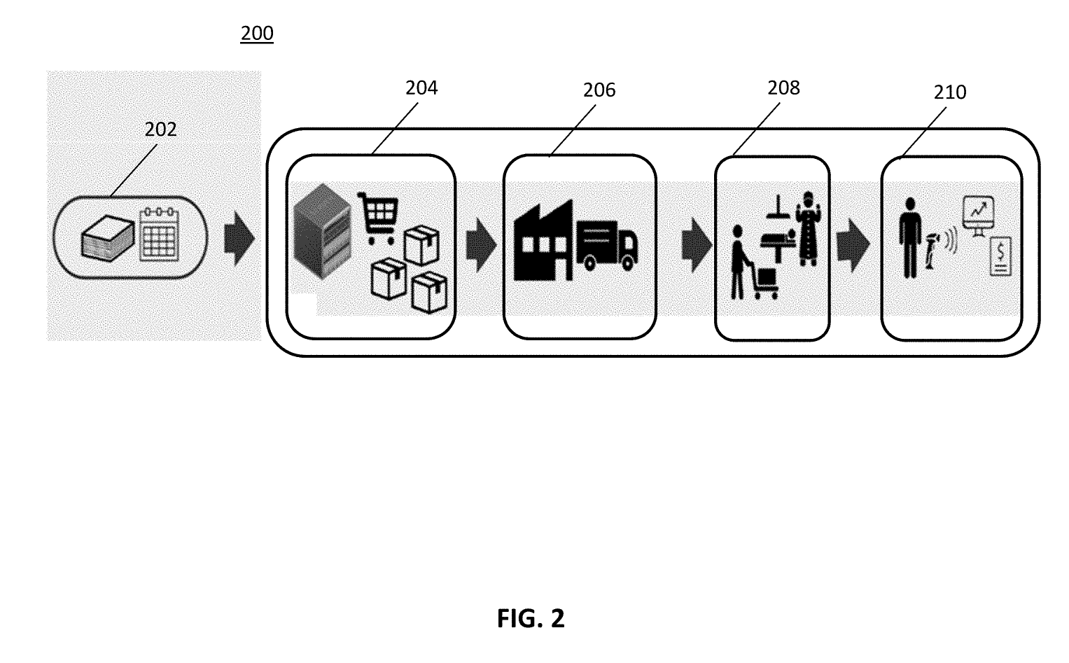

FIG. 2 illustrates a new healthcare supply chain management system 200, according to some embodiments. As shown in FIG. 2, the healthcare supply chain management system 200 comprises an order management system 204, a fulfillment capability and warehouse management system 206, an in-hospital supply management system 208, and a post procedure processing and closed loop data system 210 according to some embodiments. In some embodiments, the healthcare supply chain management system 200 receives EMR data inputs 202. In some embodiments, the EMR data inputs 202 may comprise preference card and procedure schedule data received from EMR. In some embodiments, the order management system 204 compares the received EMR data inputs 202 with existing ERP system information or catalogs to create customized orders based on the received EMR data inputs 202 with ongoing transparency of the order and item status. For example, the order management system 204 creates customized orders using the procedure schedule data and the preference card data. In some embodiments, the fulfillment capability and warehouse management system 206 manages inventory, fulfills orders, scans inventory to an order, tracks order status, and delivers supplies for each case in consolidated containers to the hospital at agreed time windows. In some embodiments, the in-hospital supply management system 208 accounts for the containerized orders received at the hospital for each patient procedure and adds to case cart processing efforts. The in-hospital management system 208 may utilize a variety of existing tools such as manual systems entry, mobile scanners, RFID scanners, voice recognition, cameras, and/or blockchain technology to account for the received orders. In some embodiments, the post procedure processing and closed loop data system 210 and returns unused items by the procedure per case, thereby completing a closed loop system that supports data transparency and machine learning.

The first key element is a world-class mass-customized e-commerce fulfillment capability serving as the critical service point to a lean technology-enabled supply chain. Accordingly, some aspects of the current disclosure provide the world-class mass-customized e-commerce fulfillment capability for the health supply chain management system 200. More specifically, some aspects of the current disclosure provide one or more forward deployed fulfillment centers (FDFC) designed for mass-customized order assembly. In one non-limiting embodiment, such FDFC designed mass-customized order assembly provides: (1) inbound processing which catches defects for 6σ accuracy; (2) storage for high turns and real-time, mass-customized order assembly processing; (3) fulfilling all items within a customized order in efficient, high quality processing with full transparency and visibility throughout processing; (4) outbound processing for rapid, customized and transparent Last Mile; and (5) software/automation added to reduce defects, simplify and ease processing. Some aspects of the current disclosure provide FDFC regional network with supporting infrastructure to serve hospitals within a region. Such FDFC is designed to create a mass-customized order assembly processing that provides a regional network with supporting infrastructure to serve hospitals within a region by: (1) providing all items for a specific procedure in sealed containers for secure, sterile, and traceable transport; (2) providing, in one non-limiting embodiment, a single FDFC that can service an area of 250 miles with 500 k orders/annum (or more than 40 hospitals); (3) expanding each node to accommodate 3.5 M orders/annum; (4) developing and utilizing Last Mile Capability as dictated by density of FDFCs, urgency of replenishment, and/or inventory needs; and (5) fulfilling urgent, assisted or in-home care services utilizing purpose built Last Mile and/or existing carrier options.

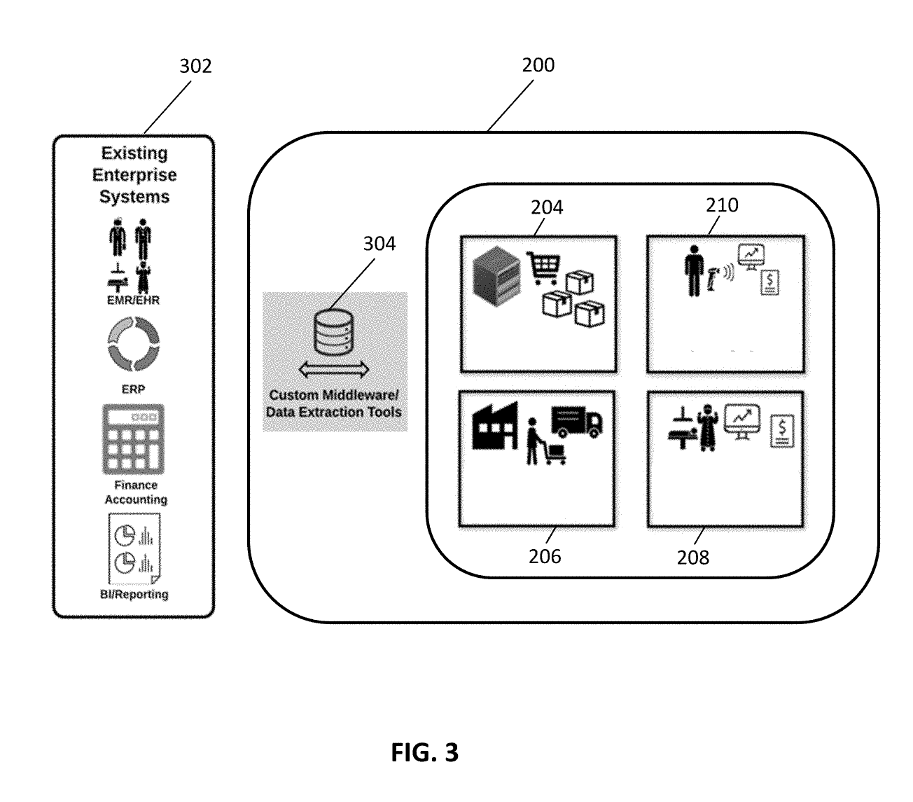

The second key element is the data extraction tools and middleware 304, as shown in FIG. 3, to integrate with existing systems 302 combined with a best in class technology to enable a closed loop real-time system to provide transparency of information at each step of the healthcare supply chain management system 200. In some embodiments, the middleware 304 may be used to extract schedule, materials, catalog, procedure outcome, and other procedure information from electronic health record systems in existing systems 302. In some embodiments, the schedule and procedure information may comprise at least one or more of electronic medical records (EMR), electronic health records (EHR), customer billing information, finance accounting information, patient outcome information by procedure, and enterprise resource planning (ERP) information. FIG. 3 illustrates the tools and middleware 304 provided by the healthcare supply chain management system 200.

The third key element is the machine learning, advanced algorithms and recommendation engines to empower clinicians and hospital systems to drive change to costs, quality of care and patient satisfaction for the healthcare supply chain management system 200.

In some embodiments, the healthcare supply chain management system 200 comprises machine learning systems. In some embodiments, the machine learning systems comprise a recommendation engine, a learning inventory management system, and a smart component kitting system. The machine learning systems comprise a combination of unsupervised classification algorithms, predictive algorithms and real physical supply chain data feeds produce recommendations on preference card changes to reduce waste and improve item selections for clinical staff, according to some embodiments.

In some embodiments, the usage data gathered via the middleware and proprietary systems, for example, the order management system 204, the fulfillment capability and warehouse management system 206, the in-hospital supply management system 208, and the post procedure processing and closed loop data system 210, will be utilized to populate machine learning tools and components of the machine learning systems, e.g. recommendation engines. In some embodiments, the usage data may include, but is not limited to, various sources of information such as the costs of items, usages of items, waste, outcomes, and clinical/patient satisfaction with a particular medical procedure that can then be compared across a range of medical procedures, clinicians, hospitals, and provider networks to enable greater transparency of information, improved clinical decisions, and implement machine learning tools to provide improved costs, outcomes, patient care, and satisfaction across clinicians and patients. In some embodiments, the usage data is obtained and stored in an order and returns database within the healthcare supply chain management system 200.

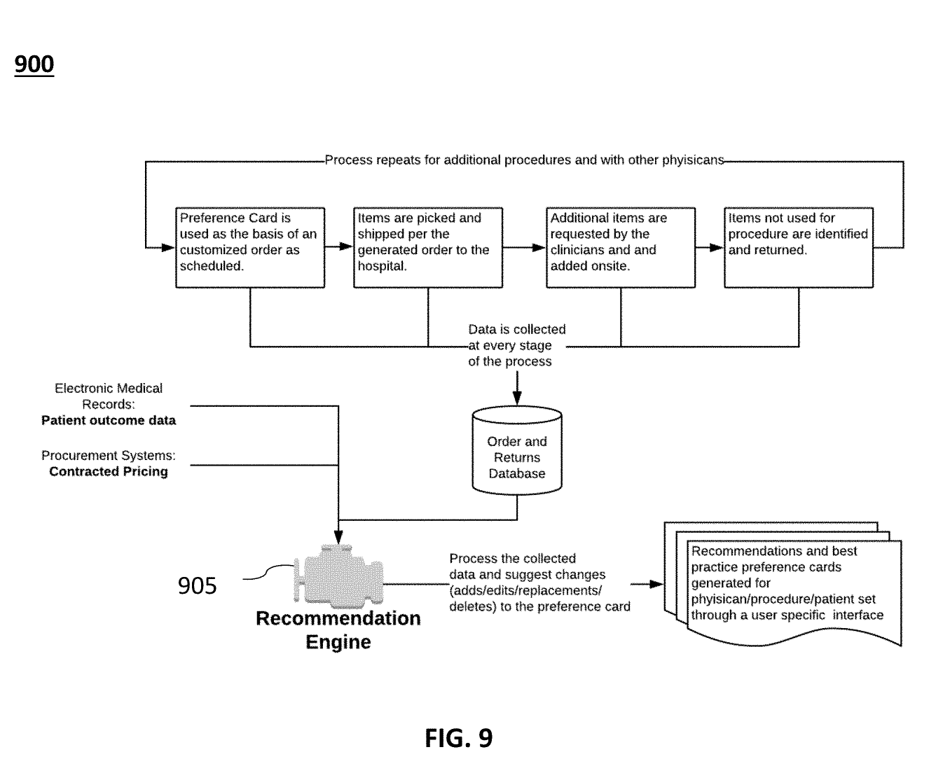

In some embodiments, the machine learning systems comprise a recommendation engine. FIG. 9 illustrates a process 900 performed by the recommendation engine 905 according to one embodiment. As shown in FIG. 9, the recommendation engine 905 obtains information regarding medical items for a particular medical procedure according to some embodiments. In some embodiments, the information is obtained via the middleware and proprietary systems, for example, the order management system 204, the fulfillment capability and warehouse management system 206, the in-hospital supply management system 208, and the post procedure processing and closed loop data system 210. In some embodiments, the information is obtained from the order and returns database. In some embodiments, the information is based on available scheduling, preference card, patient outcomes, catalog or ERP data on items purchasing, and procedure data extracted from existing hospital systems using the middleware. In some embodiments, the information is based on medical items picked and shipped per generated order for a hospital. In some embodiments, the information is based on additional items requested by clinicians. In some embodiments, the information is based on items not used for a medical procedure.

As shown in FIG. 9, the recommendation engine 905 processes the obtained information according to some embodiments. In some embodiments, the recommendation engine 905 utilizes the obtained information to compare and/or contrast with existing usage data using algorithms or systemic analytics to recommend a better option regarding the medicals supplies to be used for the particular medical procedure. In some embodiments, the recommendation engine 905 converts the obtained information related to a surgeon, surgeon expertise, medical procedure, patient, previous medical procedures, medical procedure outcomes, transportation and cost into feature vectors. In such embodiments, the feature vectors are then used to provide recommendations for changes to stock keeping units (SKUs) or quantities of SKUs needed to perform a medical procedure.

As shown in FIG. 9, the recommendation engine 905 generates recommendations. In some embodiments, the recommendation engine generates recommendations and best practice preference cards for a specific physician, medical procedure, and/or a patient. The recommendation engine allows the healthcare supply chain management system 200 to utilize obtained information to provide recommendations of supplies to surgeons/clinicians across the network on lower cost and improved patient outcomes. The recommendation engine also allows for weighting based on field leaders or other factors to improve supply selection.

In some embodiments, the machine learning systems comprise a learning inventory management system. In some embodiments, the learning inventory management system includes, but is not limited to, the following components: demand tracking, supplier performance tracking, inventory lead time tracking, inventory management system, item master, and an optimization engine. The aforementioned components are used to manage purchase orders and product flow through the healthcare supply management system. In some embodiments, the demand tracking system processes data including scheduled procedures, reschedule and cancellation rates and incorporates time series forecasting and hazard models to maintain a demand curve of statistically expected demand at the SKU level and a quantified risk of stock out. In some embodiments, the supplier performance tracking system and the inventory lead time tracking system maintain statistics on fill rates, cancellation rates, and variability in lead time to produce an expectation value for lead time from all vendors at a determined maximum acceptable failure rate. In some embodiments, the inventory management system maintains a view of instock SKUs and availability for use against future demand. In some embodiments, the item master maintains cost information and ownership information for use in planning. In some embodiments, the optimization engine processes the data feeds from any of the systems included in the learning inventory management system and utilizes dynamic programming techniques and numerical methods for optimal control to plan for maximum inventory turns and lowest cost at the required instock levels and then to produce an ordering plan for the procurement system. The learning inventory management system allows the healthcare supply chain management system 200 to incorporate real demand data from scheduling systems, expected lead times and uncertainty metrics to reduce inventory levels by factors of 3 or more, according to some embodiments. The learning inventory management system allows procurement by the healthcare supply chain management system 200 in order to adjust the inventory based on actual usage, schedules, changing lead times and supply chain processes. In some embodiments, the learning inventory management system is integrated with existing manufacturers or vendors to improve the information and forecasting to optimize the end to end supply chain costs reducing the overall costs within the healthcare supply chain.

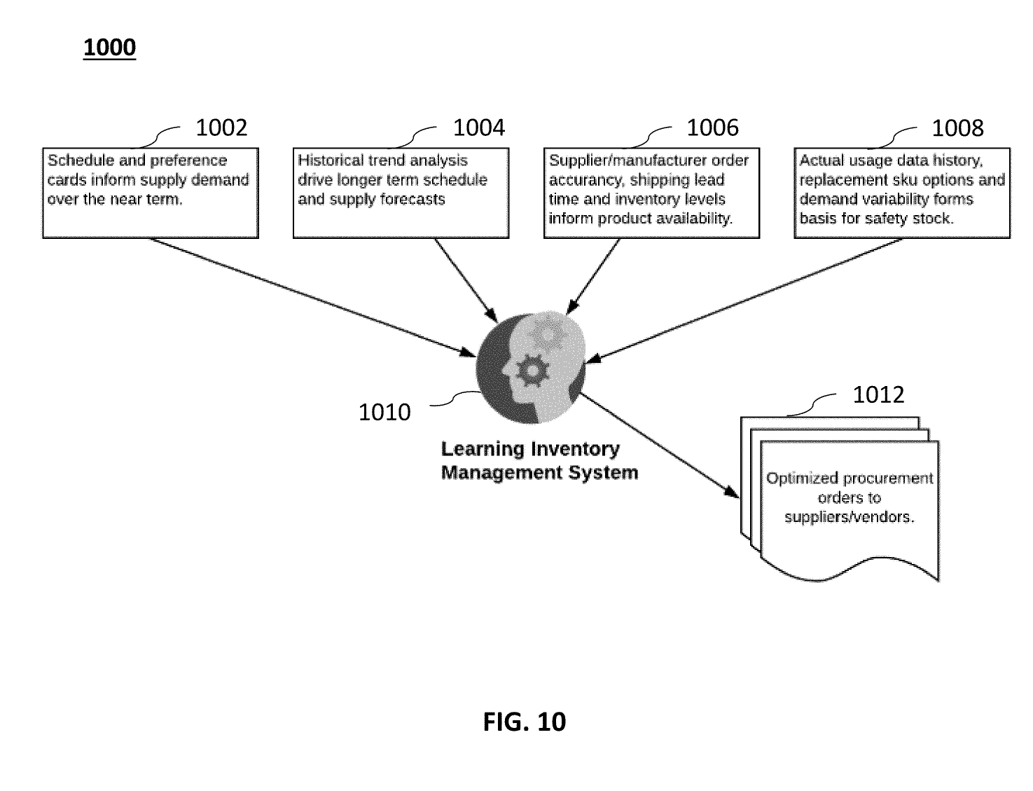

FIG. 10 illustrates a process 1000 performed by the learning inventory management system according to one embodiment. As shown in FIG. 10, the learning inventory management system obtains information as shown in steps 1002, 1004, 1006, and 1008. In some embodiments, the learning inventory management system obtains information based on scheduling and preference cards containing information regarding supply demand over a near term as shown in step 1002. In some embodiments, the learning inventory management system obtains information based on a historical trend analysis directed to a longer term schedule and supply forecasts as shown in step 1004. In some embodiments, the learning inventory management system obtains information based on supplier/manufacturer order accuracy, shipping lead time, and inventory levels reflecting information regarding product availability as shown in step 1006. In some embodiments, the learning inventory management system obtains information based on actual usage data history, replacement SKU options, and demand variability, which provides information regarding safety stock as shown in step 1008. In some embodiments, the information obtained in steps 1002, 1004, 1006, and 1008 may be obtained via the middleware and proprietary systems, for example, the order management system 204, the fulfillment capability and warehouse management system 206, the in-hospital supply management system 208, and the post procedure processing and closed loop data system 210.

In step 1010, the learning inventory management system processes the information obtained in any combination of steps 1002, 1004, 1006, and 1008. In some embodiments, the learning inventory management system aggregates demand, historical and inventory data to optimize safety stock level and reduce errors, obsolescence, and holding costs.

In step 1012, the learning inventory management system optimizes procurement orders to suppliers and/or vendors based on the processed information in step 1010.

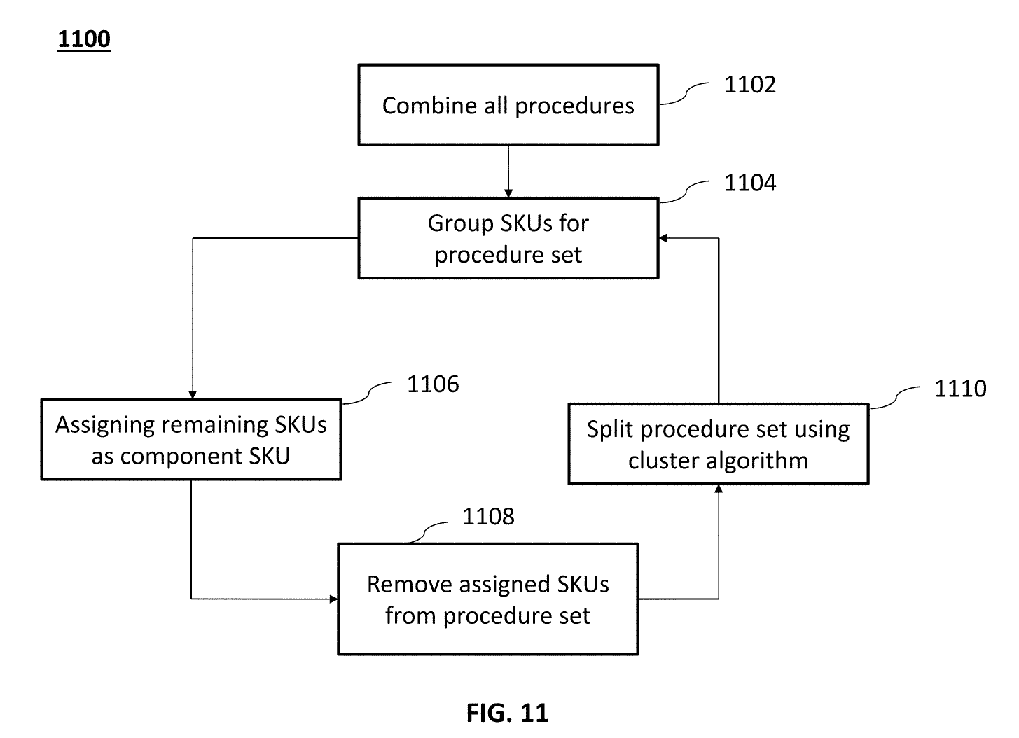

In some embodiments, the machine learning systems comprise a smart component kitting system. Current kitting processes aggregate items required for a specific procedure for multiple surgeons and hospitals as pre-kit items that results in more than 20% waste. In some embodiments, the smart component kitting system obtains usage data regarding a particular procedure or a set of procedures and prepares SKUs based on the obtained usage data. In some embodiments, the smart component kitting system in the healthcare supply chain management system uses an iterative process of matrix operations and clustering to produce component SKUs for use in assembling zero waste procedure kits. FIG. 11 illustrates an embodiment of the iterative process 1100. The process 1100 may begin with step 1102 by combining all procedures into an N×K matrix where N is the number of procedure types and K is the total set of all SKUs in the procedure set according to some embodiments. In step 1104, SKUs included in a procedure set are grouped together. In some embodiments, SKUs that are not included in a procedure receive a zero value in a procedure set. In step 1106, the remaining SKUs are assigned as an active smart component using advanced algorithms. In step 1108, the assigned SKUs are removed from the original matrix. In step 1110, a clustering algorithm is performed with a target of 2 clusters. Steps 1104 through 1110 are repeated with an increasing number of clusters until all SKUs are assigned to a smart component or the opportunity for additional component SKUs does not meet minimum demand requirements. The component building algorithm described above is rerun at recurring intervals to maintain a valid list of component SKUs over time with no analyst interaction. As described above, the smart component kitting system in the healthcare supply chain management system 200 automatically clusters SKUs into component parts that supply larger kits with zero waste for specific procedures and adjust to SKU changes automatically over time, according to some embodiments.

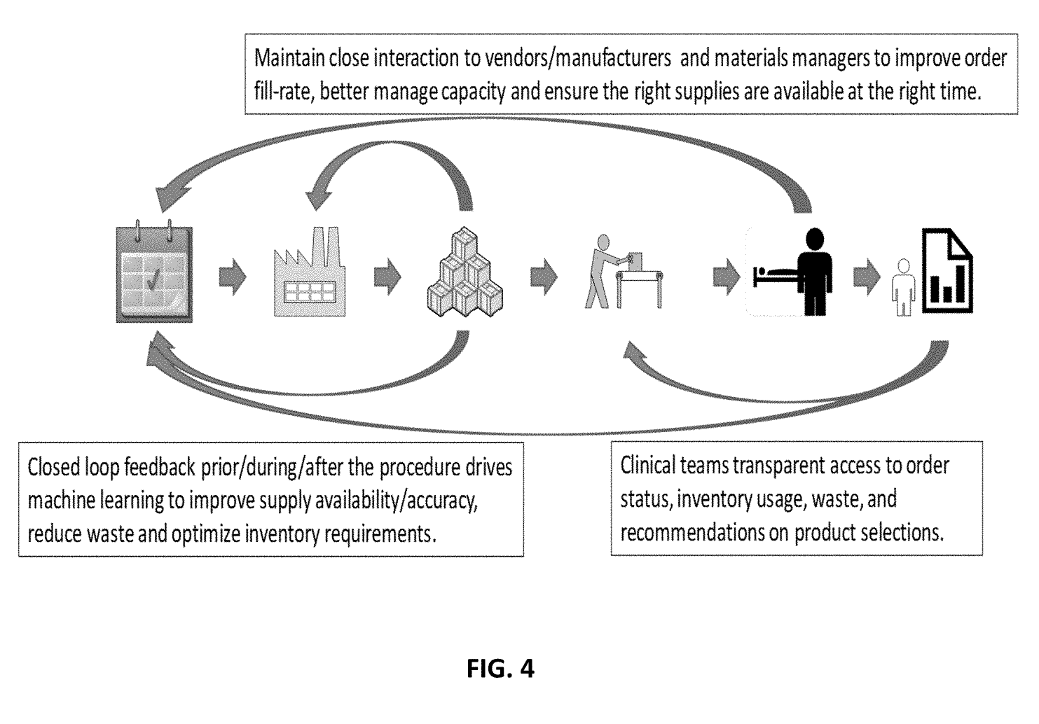

In accordance with some non-limiting embodiments disclosed herein, FIG. 4 illustrates the benefits of the healthcare supply chain management system 200 which include, but are not limited to: (1) maintaining close interaction to vendors/manufacturers and materials managers to improve order fill rates, (2) improved management of capacity and ensured availability of right supplies at the right time, (3) closed loop feedback prior/during/after a medical procedure drives machine learning to improve supply availability and accuracy, thereby reducing waste and optimizing inventory requirements, (4) clinical teams are provided with transparent access to order status, inventory usage, waste and recommendations regarding medical product selections.

In accordance with some non-limiting embodiments disclosed herein, the benefits of the healthcare supply chain management system 200 for a sample provider network of 100,000 surgeries include, but are not limited to: (1) eliminating 70% of the inventory in the hospital networks delivering a onetime cash impact of $30+M; (2) delivering a payback in the first nine months and a sustained $60+M operating margin improvement; (3) allowing clinicians to repurpose their time and space by removing tasks that add stress and providing information to focus on their mission of patient care enhancing satisfaction with the clinical teams; (4) supporting a new fulfillment capability allowing for delivery of services closer to the patient, including in the patient's home, enabling further revenue creation opportunities; and (5) easing hospital integrations and consolidations by using existing IT investments and contract management efforts delivering immediate results that improve clinician satisfaction and create financial synergies.

In some embodiments, the healthcare supply chain management system 200 may be connected to and use existing enterprise hospital systems to ease integration and provide a new source of information to empower clinical teams to improve. In some embodiments, the healthcare supply chain management system 200 is modelled after self-service integration systems designed to be an easy, low-cost change that is far simpler than current hospital and supply chain processes. In some embodiments, the healthcare supply chain management system 200 actively manages the backend logistics utilizing existing contracts and agreements to ensure a smooth transition to the healthcare supply chain management system 200. Most importantly, healthcare supply chain management system 200 eliminates the disjointed efforts to manage inventory in a hospital which greatly simplifies the conventional healthcare supply chain by removing the complexity and burdens on the clinician and hospital to enable the focus on the mission at hand—cost effective, high quality patient care.

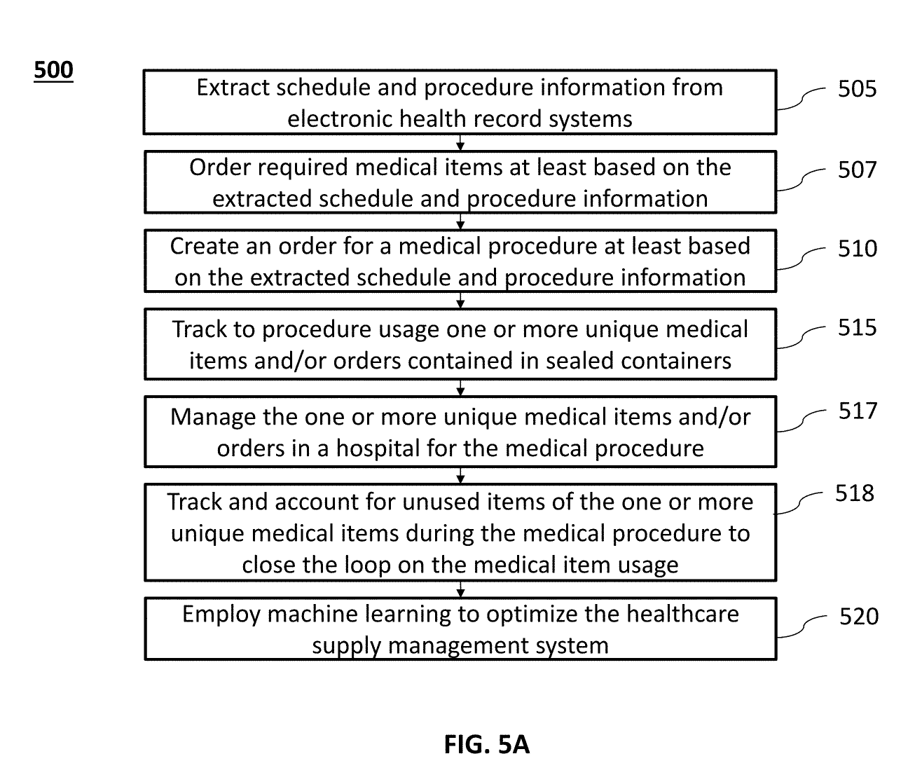

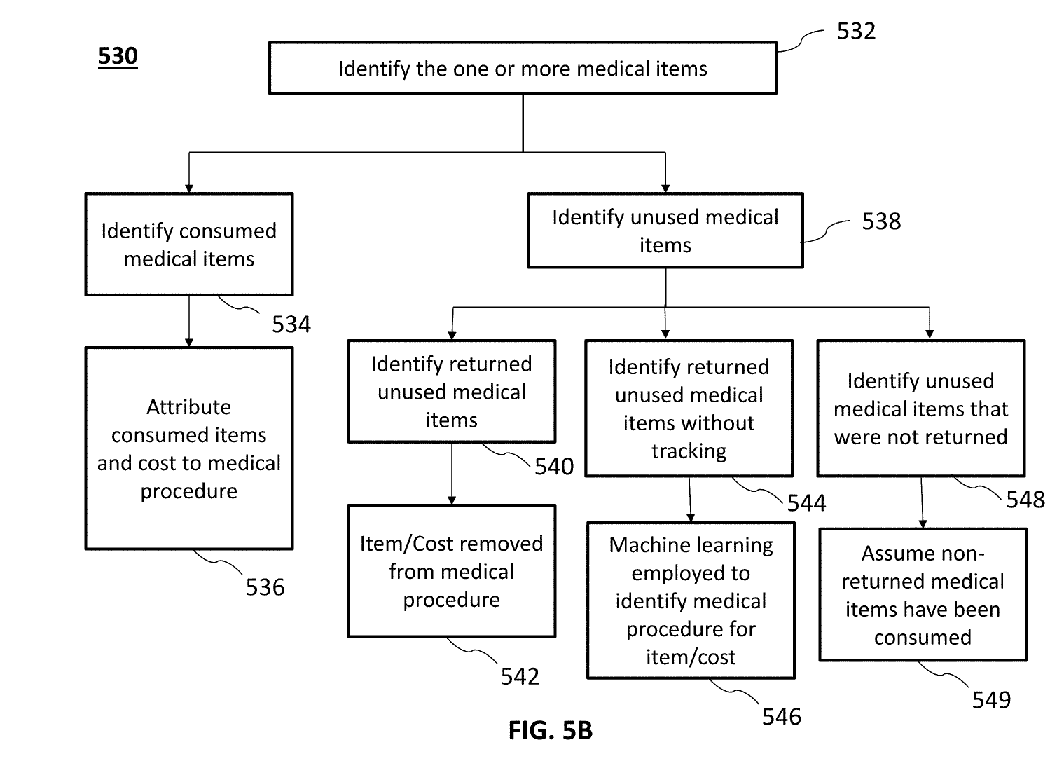

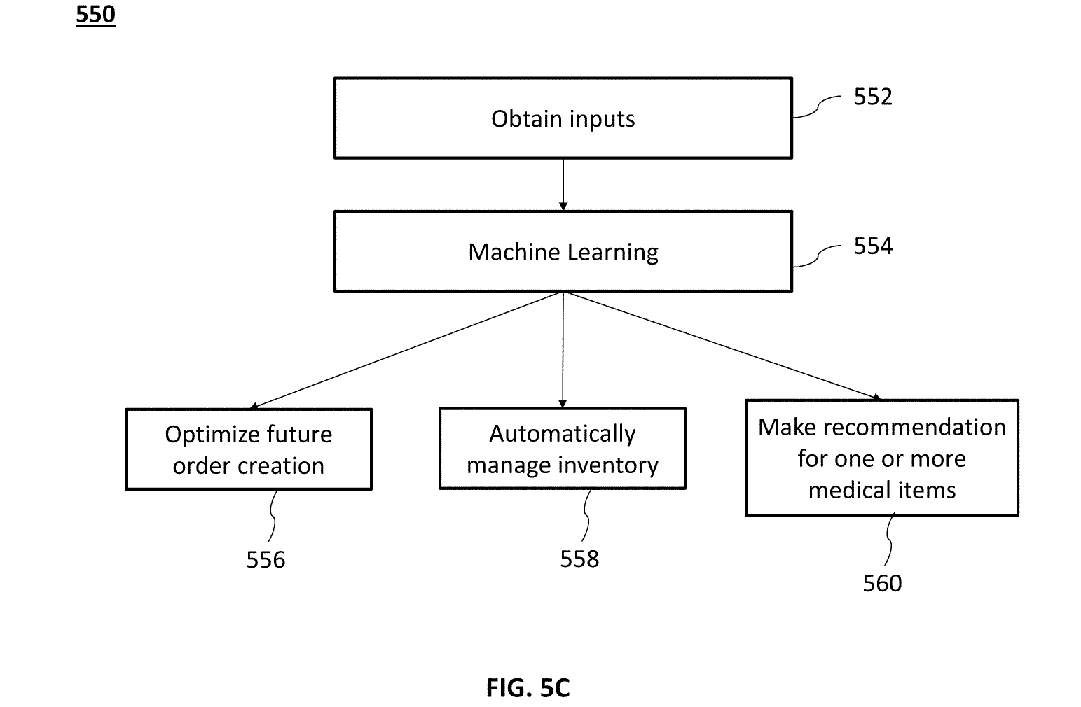

FIG. 5A illustrates a flowchart of a method 500 for a healthcare supply chain management system according to one embodiment.

In some embodiments, the method 500 may include a step 505, in which a schedule and procedure information is extracted from an electronic health record system. In some embodiments, the schedule and procedure information may comprise at least one or more of electronic medical records (EMR), electronic health records (EHR), customer billing information, finance accounting information, and enterprise resource planning (ERP) information. In some embodiments, middleware 304 may be used to extract the schedule and procedure information from the electronic health record system.

In some embodiments, the method 500 may include a step 507, in which required medical items are ordered at least based on the extracted schedule and procedure information. In some embodiments, ordering the required medical items may further comprise scheduling replenishment of the required medical items into a forward deployed fulfillment center (FDFC).

In some embodiments, the method 500 may include a step 510, in which an order for a medical procedure is created at least based on the extracted schedule and procedure information.

In some embodiments, the method 500 may include a step 515, in which one or more unique medical items and/or orders are contained in sealed containers and tracked to procedure usage. In some embodiments, barcodes attached to the one or more medical items may be scanned to track the one or more medical items. In some other embodiments, RFID scanning may be used to track the one or more medical items. In yet another embodiment, visual recognition or block chain systems may be used to track the one or more medical items. In some embodiments, tracking the one or more medical items may comprise tracking the one or more medical items delivered to a point of use at the facility and tracking any non-used items of the one or more medical items delivered to the point of use.

In some embodiments, the method 500 may include a step 517 in which the contained one or more unique medical items and/or orders in a hospital are managed for the medical procedure. In some embodiments, managing and systemically tracking the order for the medical procedure may further comprise scheduling delivery of the required medical items to a facility conducting the medical procedure.

In some embodiments, the method may include a step 518 in which unused items of the one or more unique medical items during the medical procedure are tracked and accounted for to close the loop on the medical item usage.

Steps 515, 517, and 518 are illustrated in further detail as a method 530 in FIG. 5B according to some embodiments. In step 532, the one or more unique medial items for the medical procedure are identified. In step 534, medical items consumed during the medical procedure are identified. In step 536, the consumed items and related costs are attributed to the medical procedure. In step 538, unused medical items during the medical procedure are identified. In step 540, unused items which have been returned are identified. In some embodiments, the unused items are returned via a unique identifiable container/bag per procedure or procedural area. In some embodiments, voice recognition, cameras, RFID, and/or other sensors (hereinafter referred to as sensor systems) may be utilized to identify the unused items. In some embodiments, the sensor systems may collect data regarding the unused items and feed the data as an input to machine learning systems to recommended future orders and updates to particular procedures, as will be described in further detail below. In such embodiments, an accurate accounting of items used for the procedure may be updated to patient billing, as shown in step 542. In step 544, unused items which have been returned without utilizing the tracking methods disclosed herein are identified. In some embodiments, voice, scanning or imaging recognition may be used to account for the items when they are being moved from the procedural room to a storage area. In some embodiments, a bayesian inference model may be utilized based on data from supply chain operations to return a probabilistic attribution model for items that allows the system to determine what items were used in a specific procedure despite lack of additional scan data from hospital staff. In step 546, machine learning may be employed to identify unused items returned without tracking and the related costs. In step 548, unused items which have not been returned are identified. In step 549, such identified unused items are considered as consumed during the medical procedure.

In some embodiments, the method 500 may include a step 520, in which machine learning may be employed to optimize the healthcare supply management system. In some embodiments, employing machine learning to optimize the healthcare supply management system comprises optimizing a future order creation for the medical procedure based on the one or more medical items that were not used. In some embodiments, optimizing the future order creation for the medical procedure further based on at least one or more of: (i) quality of the medical procedure outcome and (ii) cost of the medical items. In some embodiments, employing machine learning to optimize the healthcare supply management system comprises automatically ordering from vendors and managing an inventory at the facility based on the one or more medical items that were used and/or not used. In some embodiments, the inventory at the facility may be automatically managed further based on at least one or more of the schedule and procedure information from electronic health record systems, changing lead times, and healthcare supply chain processes. In some embodiments, employing machine learning to optimize the healthcare supply management system comprises providing a recommendation for the at least one or more medical items related to the medical procedure. In some embodiments, the employment of machine learning may replace current manual or even automated preference card processes/systems to automatically order materials for a particular procedure in combination with a specific clinician and patient. In some embodiments, the machine learning may comprise at least one or more of unsupervised classification algorithms and predictive algorithms.

FIG. 5C illustrates a flowchart of a method 550 of employing machine learning according to some embodiments. In some embodiments, step 520 of method 500 comprises the method 550.

In some embodiments, the method 550 may include a step 552 in which inputs for the machine learning are obtained. In some embodiments, the inputs are obtained by the middleware and proprietary systems. In some embodiments, the inputs comprise one or more medical items that were not used in a specific medical procedure. In some embodiments, the inputs comprise information regarding: (1) quality of the medical procedure outcome and/or (ii) cost of the medical items. In some embodiments, the inputs comprise schedule and procedure information from electronic health record systems, changing lead times, and/or healthcare supply chain processes. In some embodiments, the inputs comprise usage data as described above. For example, the usage data may include, but is not limited to, various sources of information such as the costs of items, usages of items, waste, outcomes, and clinical/patient satisfaction with a particular medical procedure that can then be compared across a range of medical procedures, clinicians, hospitals, and provider networks to enable greater transparency of information, improved clinical decisions, and implement machine learning tools to provide improved costs, outcomes, patient care, and satisfaction across clinicians and patients.

In some embodiments, a smart speaker may be integrated into the procedure or surgical rooms to capture item needs and generate orders to be fulfilled. In some embodiments, the smart speaker can capture voice commands to update inventory levels, product substitutions or if a procedure changes and a new order needs to be created. The smart speaker commands can also be deployed as a passive device that feeds data collected from the smart speaker into machine learning systems to recommended future orders and updates to particular procedures.

In some embodiments, cameras, RFID, and other sensors (hereinafter referred to as sensor systems) may be integrated into supply rooms and par locations. In some embodiments, the par locations may be used to store items not planned within a procedural order, emergent needs, or as back-up for certain product SKUs. In some embodiments, as an alternative or accompaniment to the smart speakers. The sensor systems may detect when items are removed from shelves for a specific procedure or returned for a specific procedure and feed that information to the learning inventory management system to generate orders for kits to be delivered to those locations based on demand, usage, and expected stock out levels. The sensor systems will also collect data and feed the data as an input to machine learning systems to recommended future orders and updates to particular procedures.

In step 554, machine learning is employed based on the input received in step 552. In some embodiments, the machine learning comprises utilizing the recommendation engine, the learning inventory management system, a smart component kitting system, and/or any combination of the aforementioned. In some embodiments, the machine learning may comprise at least one or more of unsupervised classification algorithms and predictive algorithms.

In some embodiments, future order creation may be optimized based on the machine learning performed as shown in step 556. In some embodiments, an inventory at a facility may be automatically managed based on the machine learning performed as shown in step 558. In some embodiments, a recommendation for at least one or more medical items related to a particular medical procedure may be made based on the based on the machine learning performed as shown in step 560.

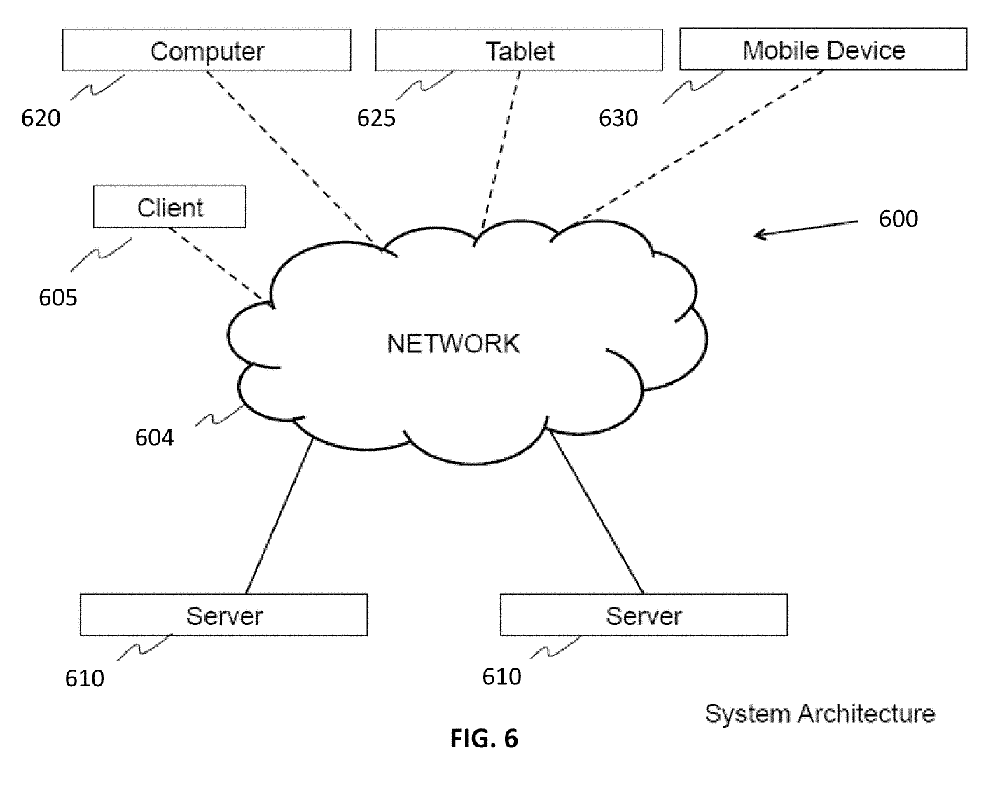

Referring to FIG. 6, an exemplary architecture of a communication system in accordance with exemplary embodiments of the current disclosure is illustrated. System 600 includes at least one web server 610 that is configured to communicate with one or more client user devices 605 through a communications network 604 (e.g., the Internet). Examples of client user devices 605 include a computer 620, a tablet 625, and a mobile device 630, among others. The systems, methods and computer program products of the present invention can, for example, be deployed as a client-server implementation, as an application service provider (ASP) model, or as a standalone application running on a user device 605. The systems, methods and computer program products of the present invention can also be deployed by providing computing services, such as hardware and/or software, in network devices, such as network nodes and/or servers 610, where the resources are delivered as a service to remote locations over a network. By way of example, this means that functionality, as described herein, can be distributed or re-located to one or more separate physical nodes or servers 610. The functionality may be re-located or distributed to one or more jointly acting physical and/or virtual machines that can be positioned in separate physical node(s), i.e. in the so-called cloud. This is sometimes also referred to as cloud computing, which is a model for enabling ubiquitous on-demand network access to a pool of configurable computing resources such as networks, servers, storage, applications and general or customized services. In some embodiments, the one or more servers 610 may provide the cloud computing with the necessary security control and authentications to allow a user to access the cloud computing using a browser on the user device 605.

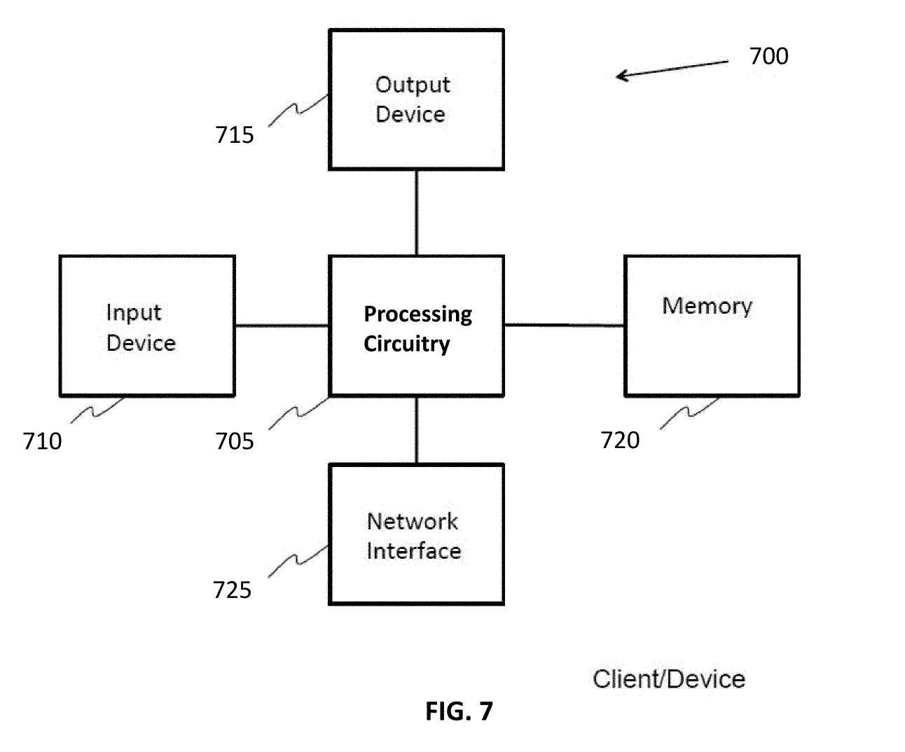

Referring to FIG. 7, a block diagram of a device 700 illustrates, for example, a client user device 605 in accordance with exemplary embodiments of the current disclosure. As shown in FIG. 7, the device 700 may include processing circuitry 705, which may include one or more processors, one or more microprocessors and/or one or more circuits, such as an application specific integrated circuit (ASIC), Field-programmable gate arrays (FPGAs), etc.

The device 700 may include a network interface 725. The network interface 725 is configured to enable communication with a communication network, using a wired and/or wireless connection.

The device 700 may include memory 720, which may include one or more non-volatile storage devices and/or one or more volatile storage devices (e.g., random access memory (RAM)). In instances where the device 700 includes a microprocessor, computer readable program code may be stored in a computer readable medium, such as, but not limited to magnetic media (e.g., a hard disk), optical media (e.g., a DVD), memory devices (e.g., random access memory), etc. In some embodiments, computer readable program code is configured such that when executed by processing circuitry, the code causes the device to perform the steps described above. In other embodiments, the device is configured to perform steps described above without the need for code.

The device 700 may include an input device 710. The input device 710 is configured to receive an input from either a user or a hardware or software component. Examples of an input device 710 include a keyboard, mouse, microphone, touch screen and software enabling interaction with a touch screen, etc. The device may also include an output device 715. Examples of output devices 715 include monitors, televisions, mobile device screens, tablet screens, speakers, etc. The output device 715 can be configured to display images or video or play audio to a user. One or more of the input and output devices can be combined into a single device.

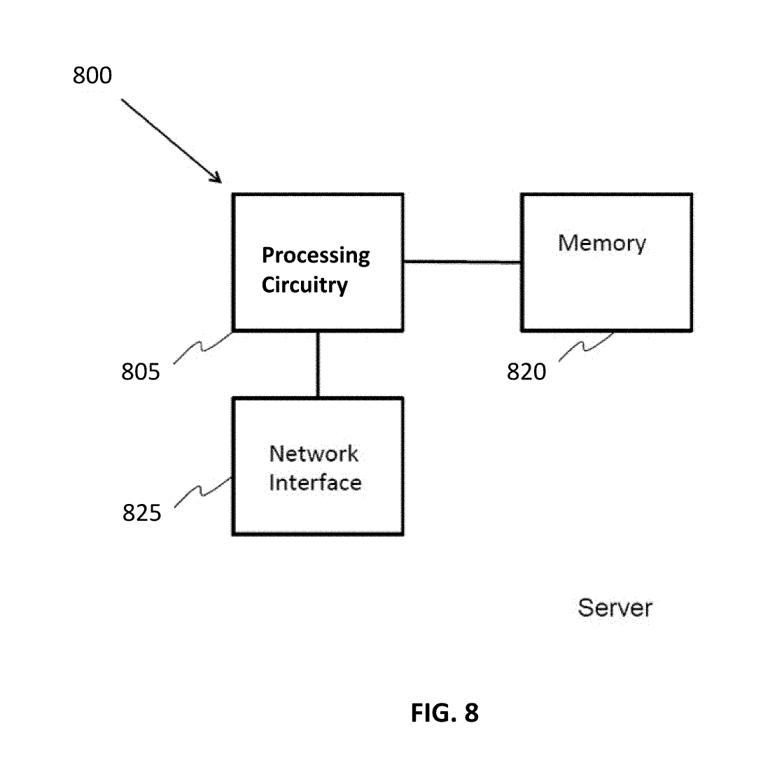

Referring now to FIG. 8, a block diagram of a server in accordance with exemplary embodiments of the current disclosure is illustrated. As shown in FIG. 8, the server 800 may include a network interface 815 for transmitting and receiving data, processing circuitry 805 for controlling operation of the server device 800, and a memory 810 for storing computer readable instructions (i.e., software) and data. The network interface 815 and memory 810 are coupled to and communicate with the processor 805, which control their operation and the flow of data between them.

Processing circuitry 805 may include one or more processors, one or more microprocessors and/or one or more circuits, such as an application specific integrated circuit (ASIC), Field-programmable gate arrays (FPGAs), etc. Network interface 825 can be configured to enable communication with a communication network, using a wired and/or wireless connection. Memory 810 may include one or more non-volatile storage devices and/or one or more volatile storage devices (e.g., random access memory (RAM)). In instances where server system 800 includes a microprocessor, computer readable program code may be stored in a computer readable medium, such as, but not limited to magnetic media (e.g., a hard disk), optical media (e.g., a DVD), memory devices (e.g., random access memory), etc. In some embodiments, computer readable program code is configured such that when executed by processing circuitry, the code causes the device to perform the steps described above. In other embodiments, the device is configured to perform steps described above without the need for code.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

What is claimed is:

1. A method for a healthcare supply chain management system, the method comprising:
extracting schedule and procedure information from electronic health record systems;
ordering required medical items at least based on the extracted schedule and procedure information;
creating an order for a particular medical procedure at least based on the extracted schedule and procedure information, wherein the order comprises a request for at least one or more medical items related to the particular medical procedure;
managing the order for the particular medical procedure; and
employing machine learning to optimize the healthcare supply management system.

2. The method of claim 1, wherein the schedule and procedure information comprises at least one or more of electronic medical records (EMR), electronic health records (EHR), customer billing information, finance accounting information, and enterprise resource planning (ERP) information.

3. The method of claim 1, wherein managing the order for the particular medical procedure comprises:
scheduling replenishment of the one or more medical items related to the particular medical procedure at a warehouse; and
scheduling delivery of the one or more medical items to a facility conducting the particular medical procedure.

4. The method of claim 3, wherein managing the order for the medical procedure further comprises:
fulfilling the one or more medical items using mass customized e-commerce fulfillment capabilities.

5. The method of claim 3, wherein managing the order for the medical procedure further comprises:
tracking the one or more medical items delivered to the facility, wherein tracking the one or more medical items comprises tracking the one or more medical items delivered to a point of use at the facility and tracking any non-used items of the one or more medical items delivered to the point of use.

6. The method of claim 5, wherein at least one of barcodes, RFID, voice recognition, cameras, visual recognition systems, and a block chain system is used to track the one or more medical items delivered to the facility.

7. The method of claim 3, wherein managing the order for the medical procedure further comprises:
determining whether all of the delivered one or more medical items were used in the medical procedure; and
as a result of determining that all of the one or more medical items were not used in the medical procedure, determining one or more medical items that were not used in the medical procedure.

8. The method of claim 7, wherein employing machine learning to optimize the healthcare supply management system comprises:
optimizing a future order creation for the medical procedure based on the one or more medical items that were not used.

9. The method of claim 8, wherein optimizing the future order creation for the medical procedure is further based on at least one or more of: (i) quality of the medical procedure outcome and (ii) cost of the medical items.

10. The method of claim 7, wherein employing machine learning to optimize the healthcare supply management system comprises:
automatically managing an inventory at the facility based on the one or more medical items that were not used.

11. The method of claim 10, wherein employing machine learning to optimize the healthcare supply management system comprises:
automatically managing the inventory at the facility further based on at least one or more of the extracted schedule and procedure information, changing lead times, and healthcare supply chain processes.

12. The method of claim 1, wherein employing machine learning to optimize the healthcare supply management system comprises:
providing a recommendation for the at least one or more medical items related to the medical procedure.

13. The method of claim 1, wherein the machine learning comprises at least one or more of unsupervised classification algorithms and predictive algorithms.

14. A healthcare supply chain management system, the system comprising:
one or more servers, wherein each of the one or more servers comprise:
memory; and
processing circuitry coupled to the memory, the processing circuitry configured to:
extract schedule and procedure information from electronic health record systems;
order required medical items at least based on the extracted schedule and procedure information;
create an order for a medical procedure at least based on the extracted schedule and procedure information, wherein the order comprises a request for at least one or more medical items related to the medical procedure;
manage the order for the medical procedure; and
employ machine learning to optimize the healthcare supply management system.

15. A computer program stored on a non-transitory computer readable medium, the computer program comprising instructions, which when executed by processing circuitry, causes the processing circuitry to:
extract schedule and procedure information from electronic health record systems;
order required medical items at least based on the extracted schedule and procedure information;
create an order for a medical procedure at least based on the extracted schedule and procedure information, wherein the order comprises a request for at least one or more medical items related to the medical procedure;
manage the order for the medical procedure; and
employ machine learning to optimize a healthcare supply management system.
